(19) United States
(12) Patent Application Publication
(10) Pub. No.: US 2025/0392203 A1
(43) Pub. Date: Dec. 25, 2025

(54) Single Inductor, Multiple Input and Multiple Output DC-DC Converter

(71) Applicant: TEXAS INSTRUMENTS INCORPORATED, Dallas, TX (US)

(72) Inventors: Venkatesh Kadlimatti, Hubli (IN); Atul Ramakant Lele, Bangalore (IN); Rinu Mathew, Bangalore (IN); Khyati Bansal, Sriganganagar (IN)

(21) Appl. No.: 19/194,009

(22) Filed: Apr. 30, 2025

(30) Foreign Application Priority Data
Jun. 24, 2024 (IN) 202441048380

(51) Int. Cl. H02M 1/00; H02M 3/07; H02M 3/158

(52) U.S. Cl. CPC H02M 1/009; H02M 3/07; H02M 3/1582

(57) ABSTRACT

A single-inductor direct current (DC) to DC (DC-DC) converter may be used for both buck-boost operation and for buck operation. The DC-DC converter may have a buck-boost phase, using the inductor, and which includes charging a first capacitor using energy from a battery source. The DC-DC converter may also have a buck phase, using the same inductor, and which may transfer current from the first capacitor to a second capacitor at a current level that may be inaccessible from the battery source. The higher current may be used to power operations, such as radiofrequency (RF) operations.

### CROSS-REFERENCE TO RELATED APPLICATIONS

The present application claims the benefit of Indian Patent Application number 202441048380, filed Jun. 24, 2024, the disclosure of which is hereby incorporated by reference in its entirety.

### TECHNICAL FIELD

The present disclosure relates generally to an electronic system and method, and, in particular embodiments, to a single inductor, multiple input and multiple output DC-DC converter.

### BACKGROUND

Processing devices, such as microcontroller units (MCUs), are designed to run software programs and perform functions enabled by running the software programs. To do so, MCUs have processing nodes configured to execute software from memory and power management units to drive the processing nodes and various elements of the MCUs. The power management units may include a power supply (e.g., a battery) and one or more power converters, power-up circuits, controllers, and drivers to ensure a requisite amount of power is provided to the processing nodes at certain times. The components of an MCU, including components of the power management unit, may be designed to function within a specific voltage range. Thus, MCUs may be limited in choices for a power supply based on the design constraints of the components of the MCU.

### SUMMARY

In accordance with an embodiment, a method including: during a first phase, operating a direct current (DC) to DC (DC-DC) converter in a buck mode, boost mode, or buck-boost mode, including delivering energy from a battery to a first capacitor using an inductor; and during a second phase, operating the DC-DC converter in buck mode, including delivering energy from the first capacitor to a second capacitor using the inductor.

In accordance with an embodiment, an electronic circuit including: a first current path including: a first terminal; a second terminal coupled to the first terminal; a third terminal configured to be coupled to the second terminal via an inductor; a fourth terminal; and a first transistor having a current path coupled between the third and fourth terminals; and a second current path including: the second terminal and the third terminal; a fifth terminal; and a second transistor having a current path coupled between the second terminal and the fifth terminal.

In accordance with an embodiment, an integrated circuit including: a first terminal; a second terminal coupled to the first terminal; a first transistor having a current path coupled between the first terminal and the second terminal; a second transistor having a current path coupled between the second terminal and a first power terminal; a third terminal; a fourth terminal; a third transistor having a current path coupled between the third terminal and the fourth terminal; a fifth terminal; a fourth transistor having a current path coupled between the second terminal and the fourth terminal; and a voltage regulator having an input coupled to the fourth terminal and an output coupled to the fifth terminal.

In accordance with an embodiment, an integrated circuit (IC) including: a first terminal configured to be coupled to an inductor; a second terminal configured to be coupled to the inductor; a third terminal configured to be coupled to a battery; a fourth terminal configured to be coupled to a first capacitor; a fifth terminal configured to be coupled to a second capacitor and to a radio frequency (RF) circuit; a first transistor disposed in a current path between the second terminal and the fifth terminal; a direct current (DC) to DC (DC-DC) converter configured to operate: in a forward mode in which the DC-DC converter receives power to charge the first capacitor via the first terminal, the second terminal, the third terminal, and the fourth terminal; and in a reverse mode in which the DC-DC converter transfers power from the first capacitor to the RF circuit via the first transistor and the fifth terminal.

In accordance with an embodiment, an integrated circuit including: first, second, third, and fourth terminals; a first transistor having a current path coupled between the first terminal and the fourth terminal; and a DC-DC converter coupled between the second and third terminals, where the DC-DC converter is configured to: during a first phase, operate in a forward mode to deliver energy to the third terminal via the first and second terminals; and during a second phase, operate in reverse mode to deliver energy from the third terminal to fourth terminal via the first and second terminals and the current path of the first transistor.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1A shows a schematic diagram of a circuit that includes a DC-DC converter, according to an embodiment of the present disclosure;

FIGS. 1B to 1E illustrates possible current flow of the circuit of FIG. 1A during various operating phases, according to embodiments of the present disclosure;

FIGS. 2 and 3 show schematic diagrams of integrated circuits that implement the DC-DC converter of FIG. 1A, according to embodiments of the present disclosure;

FIG. 4 is an illustration of an example system implementing a controller for the circuits of FIGS. 1A-3, according to some embodiments;

FIG. 5 is an illustration of an example operation, which may be performed by the DC-DC converter of FIG. 1A, under control of a controller, according to some embodiments;

FIG. 6 is an illustration of an example operation of a finite state machine, according to some embodiments; and

FIG. 7 is an illustration of an example method, according to some embodiments.

Corresponding numerals and symbols in different figures generally refer to corresponding parts unless otherwise indicated. The figures are drawn to clearly illustrate the relevant aspects of the preferred embodiments and are not necessarily drawn to scale.

### DETAILED DESCRIPTION

The making and using of the embodiments disclosed are discussed in detail below. It should be appreciated, however, that the present disclosure provides many applicable inventive concepts that can be embodied in a wide variety of specific contexts. The specific embodiments discussed are merely illustrative of specific ways to make and use the disclosure, and do not limit the scope of the disclosure.

The description below illustrates the various specific details to provide an in-depth understanding of several example embodiments according to the description. The embodiments may be obtained without one or more of the specific details, or with other methods, components, materials and the like. In other cases, known structures, materials or operations are not shown or described in detail so as not to obscure the different aspects of the embodiments. References to “an embodiment” in this description indicate that a particular configuration, structure or feature described in relation to the embodiment is included in at least one embodiment. Consequently, phrases such as “in one embodiment” that may appear at different points of the present description do not necessarily refer exactly to the same embodiment. Furthermore, specific formations, structures or features may be combined in any appropriate manner in one or more embodiments.

Various embodiments include a single-inductor DC-DC converter, which provides both buck-boost operation and buck operation. In one example, the inductor may be used in both the buck-boost operation and the buck operation.

In one example, the DC-DC converter may be operated in a buck-boost mode to charge a first capacitor from a battery source. In the buck mode, a current direction may be reversed from the buck-boost mode, and the first capacitor may be used to charge a second capacitor via the inductor. In some examples, there may be a voltage regulator, such as a low dropout (LDO) voltage regulator coupled to both the first capacitor and the second capacitor. Such LDO voltage regulator may provide current to the second capacitor in parallel to current being provided by the buck operation. Thus, the buck operation may be supplemented by the LDO in some instances.

In one example, the first capacitor (or the battery source) may be used to provide power for a first group of circuits, such as a power on reset (POR) circuit, a brownout detection (BOD) circuit, and other appropriate circuits. The second capacitor may be used to provide power for analog circuits, such as a receiver, transmitter, or transceiver. The second capacitor may also provide power, either directly or indirectly through another voltage regulator, to a group of digital circuits. Examples of digital circuits in some embodiments may include a microcontroller, a processor, digital logic, memory, and/or the like.

An example implementation may include a radio frequency (RF) device (e.g., a transceiver) that is expected to have bursty operation but otherwise consume low or no power. Such an implementation may include a battery that has an output current limitation that is lower than an amount of current expected to be used by the RF device. The buck-boost mode of operation of the DC-DC converter may charge the first capacitor from the battery at a current level that does not exceed an operating threshold of the battery. This may be performed when the RF device is not transmitting or receiving. Once the RF device turns on, the DC-DC converter may go to the buck mode of operation, which discharges the first capacitor with a current level that is higher than the operational threshold of the battery. The current may be used to power the RF device and the digital circuits that control the RF device.

Continuing with the example, such an implementation may include any appropriate RF device, such as one that may operate according to a Bluetooth low energy (BLE) protocol, a Bluetooth protocol, an ultra-wideband (UWB) protocol, a Wi-Fi protocol, or other protocol. For instance, a UWB implementation may use UWB transmission and reception for radar purposes. In another example, a UWB implementation or BLE implementation may provide access to an automobile, unlock a door to a restricted area, or may otherwise be used to provide access or to authorize a user in possession of the RF device. Of course, those are just examples, and various embodiments may be implemented as appropriate.

A potential advantage of some embodiments may include the use of the single inductor for both buck-boost mode and buck mode. The use of a single inductor, versus multiple inductors, may save materials and costs for the device.

Another potential advantage of some embodiments may include increased efficiency due to the use of the buck mode to provide power to the analog circuits. Specifically, the buck mode of operation would generally be expected to be more efficient in providing current than would an LDO by itself, at least in some applications. Thus, some embodiments may advantageously increase battery life by reducing current during RF reception and transmission.

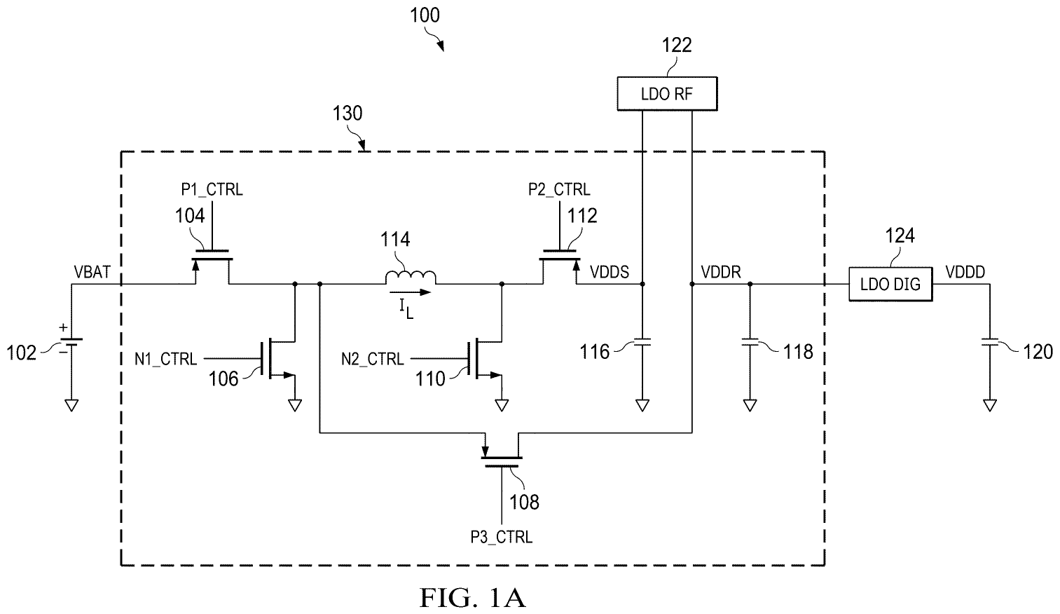

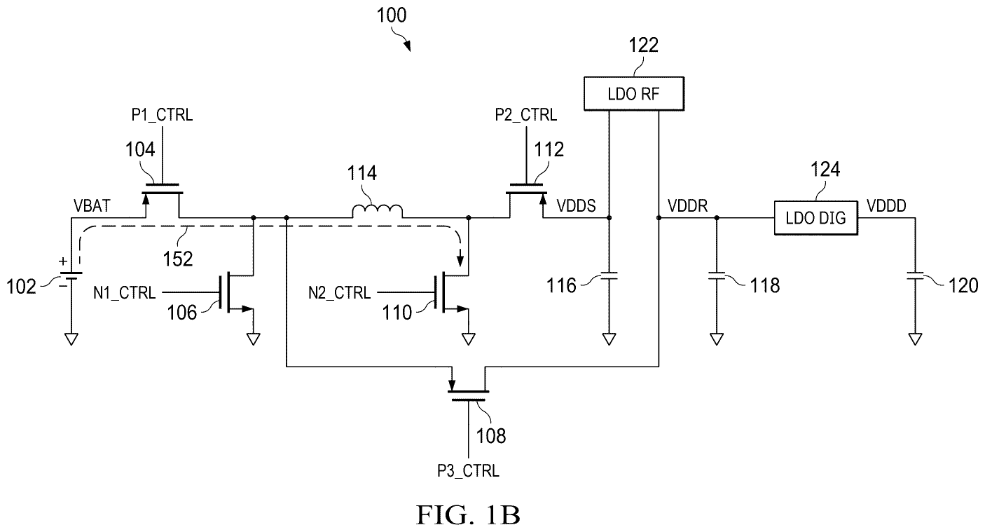

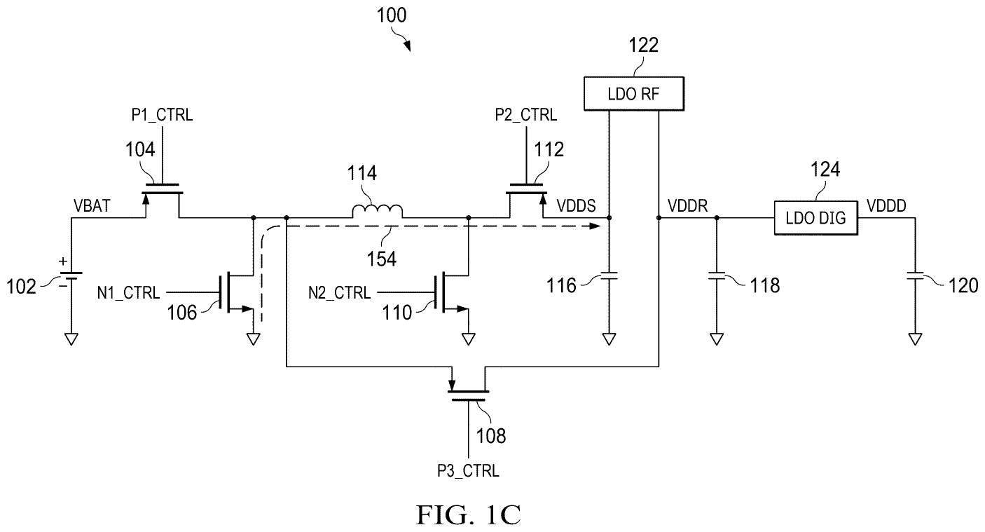

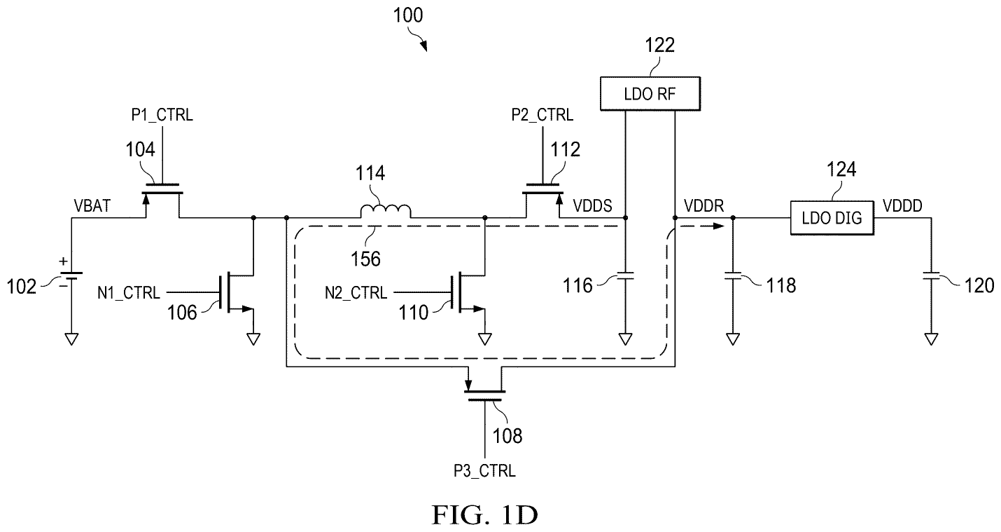

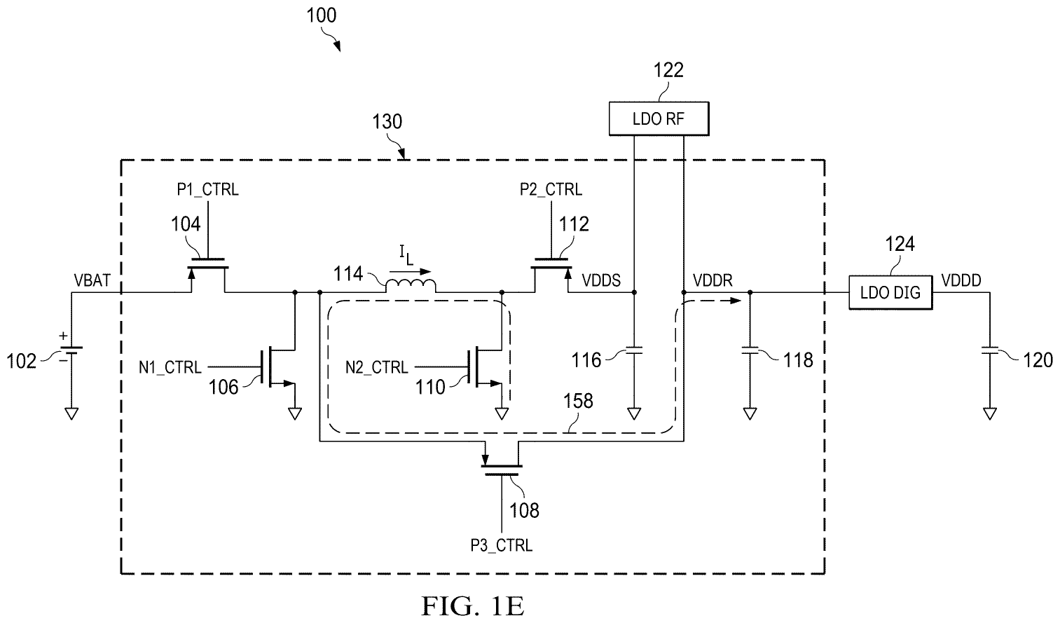

FIGS. 1A-1E illustrate an example circuit 100, for DC-DC conversion, according to some embodiments. Specifically, FIGS. 1A-1E illustrate DC-DC converter 130, which is configured to convert direct current (DC) power from battery 102 to supply devices that may be coupled to capacitor 116, capacitor 118, and/or capacitor 120. FIG. 1A illustrates an example structure for circuit 100, and FIGS. 1B-1E illustrate example operation of circuit 100.

Transistors 104, 106, 108, 110, and 112 each have a control terminal (e.g., a gate) and current path terminals (e.g., a source and a drain). In these examples, a transistor having a current path refers to a source-to-drain or drain-to-source path for current through that transistor. A given transistor may be arranged within a larger current path, such as the current paths for currents 152, 154, 156, 158 in FIGS. 1B-E. While the transistors of FIG. 1 are shown as P type metal oxide semiconductor (PMOS) and N type metal oxide semiconductor (NMOS) devices, the scope of implementations is not limited just to MOS devices. Rather, various embodiments may use other transistor technologies, such as bipolar junction transistors (BJTs) and the like.

Transistor 104 is a PMOS transistor, having its source coupled to battery 102 and its drain coupled to a first terminal of inductor 114. The transistor 106 is an NMOS transistor, having its source coupled to ground and its drain coupled to the first terminal of inductor 114. Inductor 114 has its first terminal coupled to transistors 104 and 106 (as described above) and it second terminal coupled to the drain of transistor 110 and the drain of transistor 112. Transistor 110 has its source coupled to ground, and transistor 112 has its source coupled to VDDS and to a first terminal of capacitor 116.

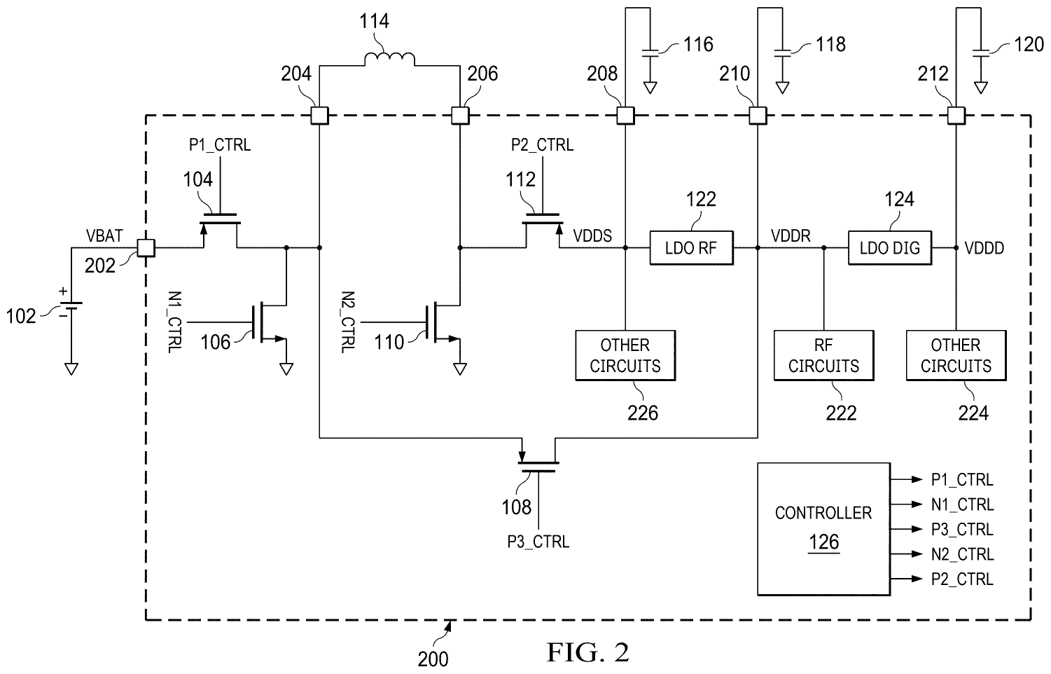

Transistor 108 is arranged so that its source is coupled to the first terminal of inductor 114, and its drain is coupled to VDDR and to a first terminal of capacitor 118. The control terminals of transistors 104, 106, 108, 110, and 112 may be coupled to a control circuit (e.g., controller 126 of FIG. 2) to turn the various transistors on and off so that the DC-DC converter 130 operates in an appropriate mode at a given time.

Capacitor 116 is arranged so that its first terminal is coupled to VDDS and its second terminal is coupled to ground. Similarly, capacitor 118 is arranged so that its first terminal is coupled to VDDR and its second terminal is coupled to ground. Capacitor 120 is arranged so that its first terminal is coupled to VDDD and its second terminal is coupled to ground.

LDO RF 122 is coupled at its input to VDDS and at its output to VDDR. LDO DIG 124 is coupled so that its input is at VDDR and its output is at VDDD.

Circuit 100 includes battery 102, DC-DC converter 130, LDOs 122, and 124, and controller 126. DC-DC converter 130 includes transistors 104, 106, 108, 110, and 112, inductor 114, capacitors 116, 118, and 120.

During normal operation, DC-DC converter 130 may alternate between a pre-charge phase (e.g., buck-boost mode), and a TX/RX phase (e.g., buck mode). During the pre-charge phase, DC-DC converter 130 may operate in a forward direction (transferring energy from battery 102 to capacitor 116). During the TX/RX phase, DC-DC converter 130 may operate in a reverse direction (transferring energy from capacitor 116 and to capacitor 118).

In the pre-charge phase, DC-DC converter 130 may operate as a buck-boost to charge capacitor 116. For example, when operating as a boost (e.g., when VBAT is lower than the target VDDS voltage), transistor 104 is on, transistors 106 and 108 are off, and transistors 110 and 112 are operated to transfer energy from VBAT to VDDS. For example, in boost mode, transistor 110 may be initially on and transistor 112 may be initially off to charge current I_{L} of inductor 114, as shown by path 152 in FIG. 1B. After charging inductor 114, energy is delivered to capacitor 116 by turning off transistors 104 and 110 and turning on transistors 106 and 112, as shown by path 154 of FIG. 1C.

In the pre-charge phase, when operating as a buck (e.g., when VBAT is higher than the target VDDS voltage), transistors 110 and 108 are off, transistor 112 is on, and transistors 104 and 106 may be switched according to a time on and time off pattern to transfer energy from VBAT to VDDS.

After the pre-charge phase, DC-DC converter 130 may transition to the TX/RX phase, in which DC-DC converter 130 operates in buck mode to transfer energy from capacitor 116 to capacitor 118, as shown by path 156 of FIG. 1D. For example, during the TX/RX phase, transistors 104 and 106 may be off, transistor 108 may be on, and transistors 110 and 112 may be switched to transfer energy from VDDS to VDDR. For instance, as shown in FIG. 1D, transistor 112 is on, transistor 110 is off, and transistor 108 is on, which allows current to flow through inductor 114 in response to the voltage difference between VDDS and VDDR. As time progresses, the current through inductor 114 may increase to reach a peak, which may be pre-programmed into a controller (e.g., controller 126 of FIG. 2). The controller may then turn transistor 112 off and turn transistor 110 on, which causes the voltage across the inductor 114 to be the difference between ground and VDDR, thereby causing the voltage to decrease from the peak to zero. Once the zero is reached, the controller may either return to the phase illustrated in FIG. 1D or may return to the pre-charge phase of FIGS. 1B-1C.

In some embodiments, during the TX/RX phase, LDO RF 122 is initially disabled (e.g., an internal pass gate (not shown) connected between the output of LDO RF 122 and VDDR is off). Once the reverse buck converter (taking energy from VDDS to VDDR) saturates (reaches a maximum allowed output current), LDO RF 122 may be enabled to supply any extra current, if needed to keep VDDR within a target voltage range. In some embodiments, the reverse buck converter does not reach the maximum allowed current for the reverse buck converter and thus does not saturate. In some such embodiments, LDO RF 122 may remain disabled during the entire TX/RX phase.

In some embodiments, the LDO RF 122 may be always on during the TX/RX phase. Specifically, the LDO RF 122 may be configured to provide current based on a voltage difference between VDDS and VDDR, such that the larger the difference, the larger the current provided by LDO RF 122 to VDDR. As in the example above, the LDO RF 122 may supply current in parallel to the buck mode operation. In an example in which more current is needed at VDDR, that may result in a larger voltage difference between VDDS and VDDR, which may cause the LDO RF 122 to provide more current. In an example in which less current or no current is needed at VDDR beyond that which is provided by the buck mode operation, that may result in a smaller voltage difference between VDDS and VDDR, which may cause the LDO RF 122 to provide less current or no current.

In some embodiments, LDO RF 122 may be omitted or not implemented. In such an example, any devices coupled to VDDR may be powered from the buck operation itself without supplemental current from LDO RF 122.

In some embodiments, during the TX/RX phase, DC-DC converter 130 may operate as a constant current source providing a constant current (e.g., the saturated current of the reverse buck converter) to VDDR via transistor 108. Specifically, while the current may appear as a sawtooth pattern, when averaged over multiple cycles, the current may be effectively a constant current, at least for a period of time at which the charge at capacitor 116 remains sufficient. Once the charge at capacitor 116 drops below a threshold, the DC-DC converter 130 may switch from TX/RX mode (e.g., buck mode) to the pre-charge mode (e.g., buck-boost mode).

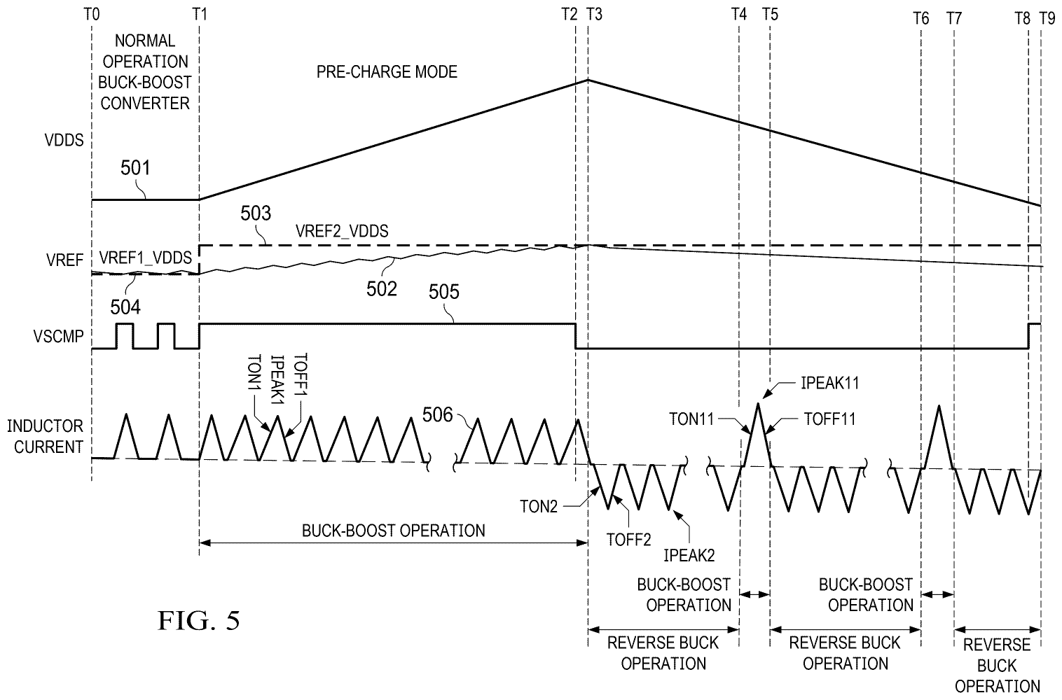

In some embodiments, DC-DC converter 130 may transition from the TX/RX phase to the pre-charge phase when the inductor current I_{L} decreases to 0 mA (e.g., at the zero-crossing). For instance, operation during the buck mode may include a sawtooth pattern (e.g., as in FIG. 5) of the current I_{L}, and the controller (e.g., 126 of FIG. 2) may end the buck mode of operation at a zero crossing rather than at non-zero current levels.

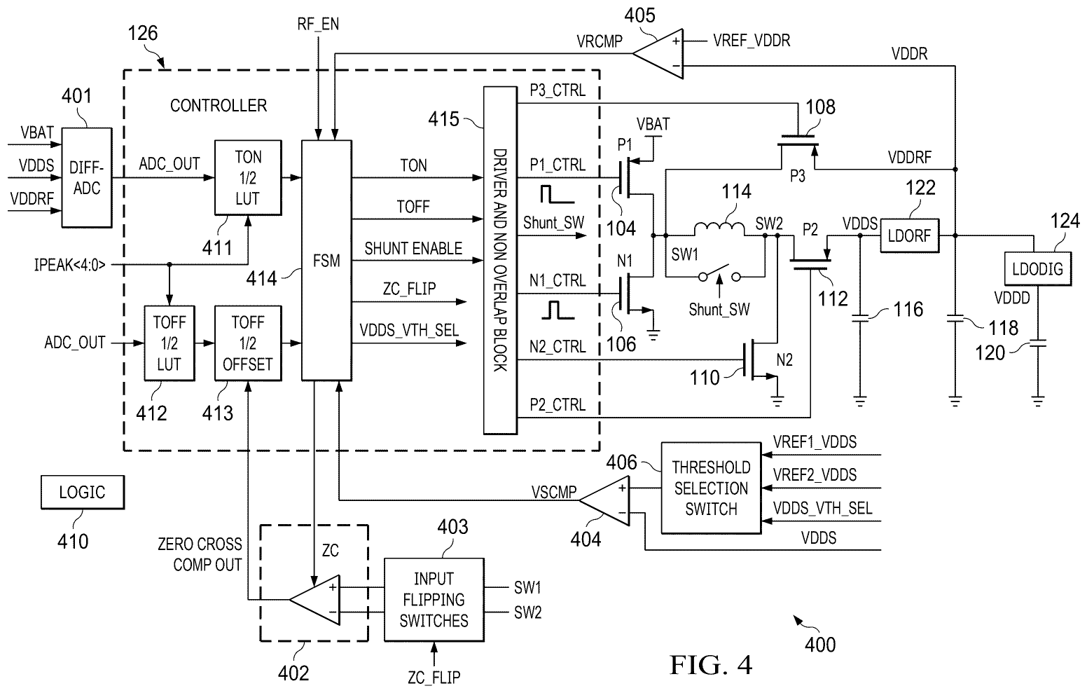

In some embodiments, DC-DC converter 130 may transition from the pre-charge phase to the TX/RX phase in response to an enable signal, such as discussed in more detail with respect to FIG. 4.

In some embodiments, the VDDS constantly increases during the pre-charge phase, such as having a linear relationship with time. Such linear relationship may be used to set time on and time off in the controller (e.g., 126 of FIG. 2) for charging.

In some embodiments, VDDS is regulated to a target voltage during the pre-charge phase. For instance, some embodiments may measure VDDS and use the VDDS as an input to the controller (e.g., 126 of FIG. 2), ending the pre-charge phase (e.g., buck-boost mode) once the VDDS reaches the target voltage.

In some embodiments, converter 130 may limit the peak current provided from battery 102 to DC-DC converter 130 to a maximum peak current. For instance, the controller (e.g., 126 of FIG. 2), may control transistor 104 to de-couple the battery 102 from the inductor 114, thereby maintaining a limit to the peak current from the battery 102.

In some embodiments, a buck converter may be more efficient in providing current than an LDO, and in some embodiments, more current can be provided to VDDR while taking less current from VDDS using the reverse buck converter (alone, or in parallel with LDO RF 122) compared to using LDO RF 122 alone. As a result, some embodiments may advantageously be able to reduce the size of capacitor 116 (e.g., by 20% or more) while providing the same current to VDDR compared to a solution that does not use a reverse buck converter, without exceeding a maximum current limit of the battery 102.

In some embodiments, the reverse buck converter functionality, and the forward buck-boost functionality (which allows for a wide input battery voltage range), may be advantageously achieved with a single inductor 114, as shown in FIG. 1A.

Advantages of some embodiments include a reduction of 15% and 25% of RF current and leakage currents on VDDR during active and standby modes, respectively.

In some embodiments, circuit 100 supports a wide range of battery voltages (e.g., VBAT from 1.2 V to 3.6 V), e.g., with a fixed VDDR voltage (e.g., 1.65 V), and a fixed VDDD voltage (e.g., 1.1 V). Other voltages and voltage ranges may also be used.

In some embodiments, battery 102 is a coin cell battery. However, the scope of embodiments may include any appropriate battery type.

In some embodiments, transistors 104, 106, 108, 110, and 112, LDOs 122 and 124, and controller 126 may be implemented as part of an integrated circuit (IC). In some embodiments, battery 102, inductor 114, and one or more (or all) of capacitors 116, 118, and 120 may be implemented external to the IC. Other implementations are also possible.

Controller 126 may provide the controlling signals for transistors 104, 106, 108, 110, and 112, as explained in more detail in FIGS. 2-4.

Some embodiments may be implemented in a UWB application (e.g., such as a keyfob) in which the current limit of the battery is 10 mA, current provided to VDDR is about 70 mA for 200 μs, and the operating voltage range for VBAT is from 1.2 V to 3.6 V, VDDR is fixed at 1.65 V. However, the scope of embodiments may be adapted for any battery voltage, battery limitations, and RF current use, so the values mentioned above are examples.

As explained above, in some embodiments, DC-DC converter 130 may operate as a bi-directional buck converter (e.g., when VBAT is higher than VDDS all the time). In such embodiment, DC-DC converter 130 may operate as a forward buck converter during the pre-charge phase, and a reverse buck converter in the TX/RX phase.

In some embodiments, DC-DC converter 130 may operate always as a boost converter during the pre-charge phase (e.g., when VBAT is lower than VDDS all the time). In such embodiment, DC-DC converter 130 may operate as a forward boost converter during the pre-charge phase and as a reverse buck converter in the TX/RX phase.

In some embodiments, the current limiter functionality of DC-DC converter 130 may be bypassed. For instance, time on and time off signals of the controller (e.g., controller 126 of FIG. 2) may increase the time on to 100% or nearly 100%, thereby allowing peak current to increase as high as may be allowed by the charge at capacitor 116.

In some embodiments, LDO DIG 124 is used to supply power digital circuits of circuit 100 (not shown) via VDDD. In some embodiments, VDDR may be used to supply power to RF analog blocks of circuit 100 (not shown).

FIG. 2 shows a schematic diagram of integrated circuit (IC) 200, according to an embodiment of the present disclosure. IC 200 includes terminals 202, 204, 206, 208, 210, and 212. In some embodiments, terminals 202, 204, 206, 208, 210, and 212 may be pads. In some embodiments, terminals 202, 204, 206, 208, 210, and 212 may be pins connected via bond wires to their respective circuits.

As shown in FIG. 2, IC 200 implements circuit 100 with a combination of elements internal to IC 200 and external to IC 200. IC 200 may also include RF circuits 222 powered by VDDR, other circuits 224 powered by VDDD, and/or other circuits 226 powered by VDDS, as shown in FIG. 2.

Other circuits 226 may be representative of one or more start-up circuits, regulator circuits, voltage reference circuits, and the like capable of being powered by battery 102 and/or VDDS and operable to provide power and control signals to controller 126. For example, other circuits 226 may include one or more of a power-on-reset (POR) circuit, a bandgap reference circuit, a brown-out detector (BOD) circuit, a low-dropout (LDO) circuit, and the like. In another example, other circuits 226 may be powered by VDDR.

RF circuits 222 may include analog circuits, such as an RF receiver, transmitter, and/or transceiver. RF circuits 222 may be controlled, at least in part, by the other circuits 224, which may be implemented as digital circuits. Other circuits 224 may include one or more microcontrollers or other processing devices, such as hardware accelerators, central processing units (CPUs), digital signal processors (DSPs), field-programmable gate arrays (FGPAs), general processing units, system control circuitry, random-access memory (RAM) read-only memory (ROM), and more. In one example, other circuits 224 may include a microcontroller or other processing device that is operable to read computer-executable code to cause components of RF circuits 222 to transmit and/or receive at certain times or transmit and/or receive certain data.

For instance, other circuits 224 may be configured to run an application to control components of RF circuits 222 to perform a function using BLE, UWB, Wi-Fi, or other protocol.

In the example of FIG. 2, in a first state, current (e.g., current 152 of FIG. 1B) may be conducted along a current path that includes terminal 202, transistor 104, terminal 204, inductor 114, terminal 206, and transistor 110. Similarly, in a second state, current (e.g., current 154 of FIG. 1C) may be conducted along a current path that includes transistor 106, terminal 204, inductor 114, terminal 206, transistor 112, and terminal 208. In a third state, current (e.g., current 156 of FIG. 1D) may be conducted along a current path that includes terminal 208, transistor 112, terminal 206, inductor 114, terminal 204, transistor 108, and terminal 210. In a fourth state, current (e.g., current 158 of FIG. 1E) may be conducted along a current path that includes transistor 110, terminal 206, inductor 114, terminal 204, transistor 108, and terminal 210.

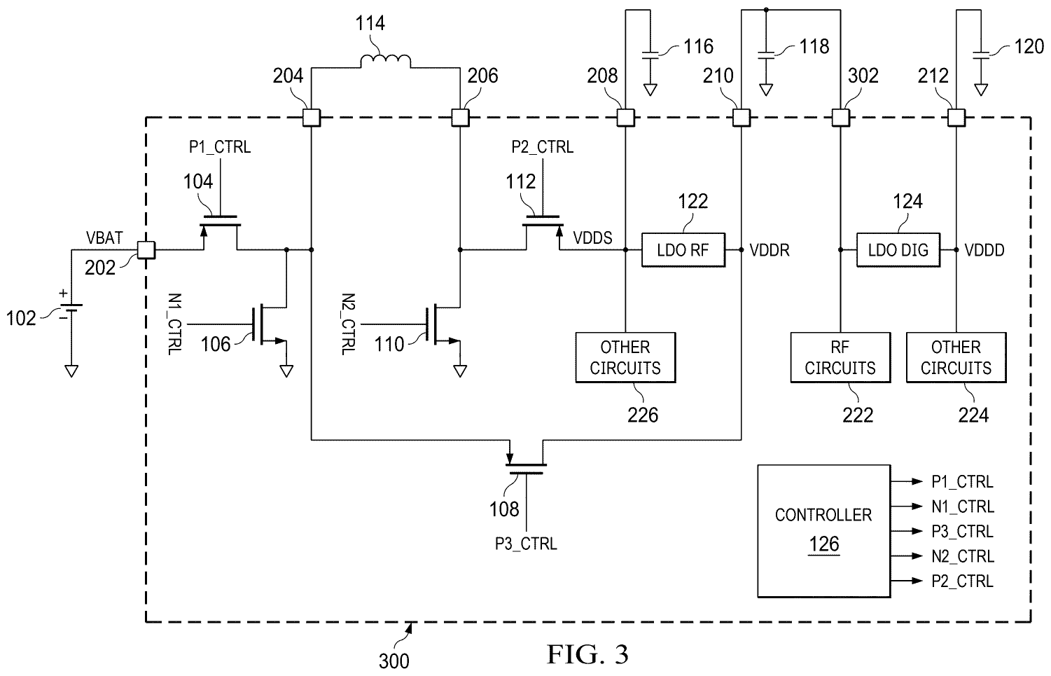

As shown in FIG. 3, in some embodiments, RF circuits 222 may be powered by VDDR via terminal 302. By powering RF circuits 222 by VDDR via terminal 302, some embodiments may advantageously reduce switching noise associated with DC-DC converter 130 (e.g., because of parasitic inductance associated with terminals 302 and 210, together with capacitor 118 may operate as a low-pass filter). Similarly, in some embodiments, other circuits 226 may be powered by VDDS via another terminal (not shown).

FIG. 4 is an illustration of an example system 400, according to some embodiments. For instance, FIG. 4 illustrates one way in which controller 126 may be adapted to control circuit 100. Such adaptation may be applied as well in a scenario in which circuit 100 is implemented within an integrated circuit, such as is shown in FIGS. 2 and 3. In other words, system 400 may be implemented in various embodiments, including any of the embodiments described above with respect to FIGS. 1A-1E and FIGS. 2 and 3, to provide control for a DC-DC converter.

System 400 includes analog-to-digital converter (ADC) 401, which receives as inputs the voltage levels at VBAT, VDDS, and VDDRF. Time-on lookup table 411 and time-off lookup table 412 receive the output of ADC 401 as well as an indication of a desired peak value of the inductor current I_{L} (IPEAK). In one example, the indication of the desired peak value may be generated by logic 410. Each of the lookup tables 411 and 412 may be configured as hardware logic and memory to store lookup tables that have entries of corresponding time on and time off values matching values of IPEAK and ADC outputs. Time-off offset block 413 may be configured to provide an offset for a time off value so that time off occurs after time on and to prevent a scenario in which a voltage or current may be undesirably shorted to ground.

In some embodiments, lookup tables 411 and 412 may be populated by data that is acquired through experiment or simulation. For instance, the entries in the lookup tables 411 and 412 may indicate relationships between the inputs VBAT, VDDS, and VDDRF as well as values for IPEAK. The outputs from lookup tables 411 and 412 may be configured so that they may provide time on and time off values to cause desired amount of current through the inductor 114. Thus, in this example, rather than measuring current, controller 126 receives information indicating voltage levels and selects entries configured to provide time on and time off so that the current in the inductor reaches a desired peak and reaches a desired zero under the operating conditions.

In some embodiments, the outputs of time-on lookup table 411 and offset block 413 may define timing to control the gates of transistors 104, 106, 108, 110, and 112, to turn those transistors on or off at desired times. For instance, in the descriptions of FIGS. 1B-1E, each of the different modes includes turning some transistors on and some transistors off. The lookup table 411, lookup table 412, and offset block 413 may provide output to appropriately turn those transistors on or off, as in the examples above. Offset block 413 may generate an appropriate offset based on the output from zero cross comparator 402. For instance, zero cross comparator 402 may receive values from flipping switches 403, where those values are based on voltages across the terminals of inductor 114. A first terminal, at SW1, is coupled to the drains of transistors 104 and 106, and a second terminal, at SW2, is coupled to the drain of transistor 110. The input signal ZC_FLIP may be generated by finite state machine 414 based on a state of the finite state machine, which may correspond to a direction of current through inductor 114.

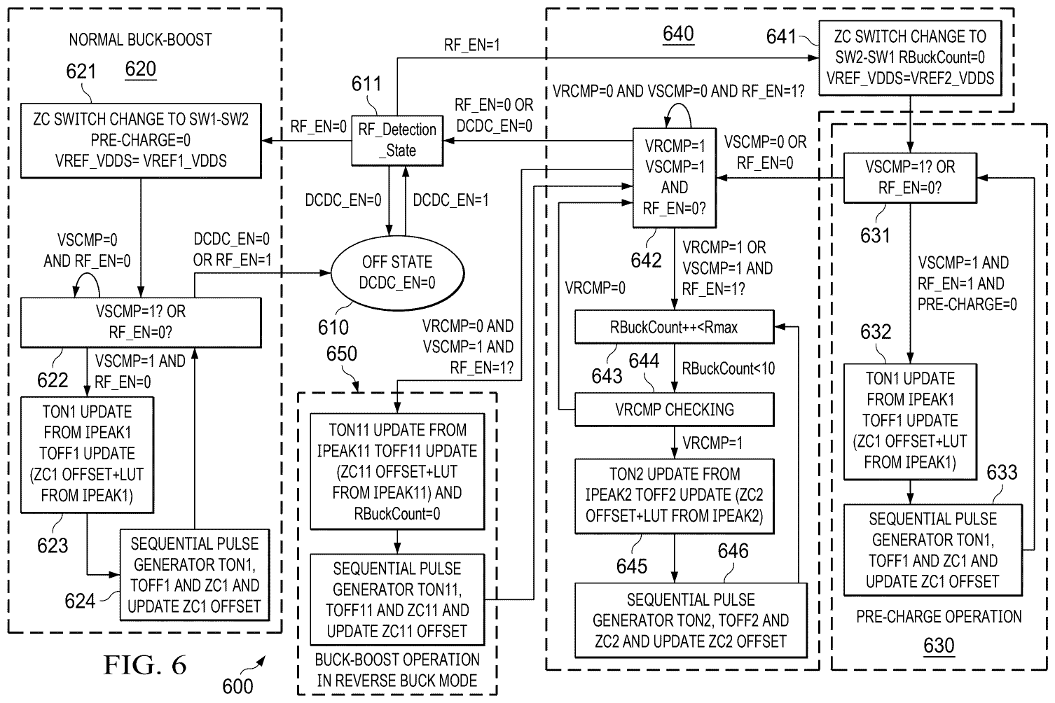

In some embodiments, finite state machine 414 may be implemented in hardware logic and may receive as inputs the values from time on lookup table 411 as well as from offset block 413. Finite state machine 414 may also receive control signals RF_EN, VSCMP, and VRCMP. The action of finite state machine 414 as well as its inputs are described in more detail with respect to FIG. 6.

The input VRCMP may be generated from comparator 405, which compares the voltage level at VDDR with VREF_VDDR. When the voltage level at VDDR drops below the reference (VREF_VDDR), the comparator 405 may output a digital 0, and when the voltage level at VDDR is above the VREF_VDDR, the comparator 405 may output a digital 1.

The input VSCMP may be generated from comparator 404, which compares a value of VDDS against any one of two reference voltages (VREF1_VDDS and VREF2_VDDS). For instance, VREF1_VDDS may be selected by logic 410 using a threshold select signal VDDS_VTH_SEL during normal operation (as in FIG. 5), and VREF2_VDDS may be selected by logic 410 during the pre-charge mode and RF mode (as in FIG. 5). In a non-divided example, VREF1_VDDS may be 1.2V and VREF2_VDDS may be 2.2V, though the scope of implementations may be adapted to use any appropriate reference voltages. In the present example, the voltage level at VDDS may be divided before the inverting input of comparator 404, though in other embodiments, VDDS may not be divided.

Finite state machine 414 may use logic to generate outputs: time on (TON), time off (TOFF), SHUNT ENABLE, ZC_FLIP, and VDDS_VTH_SEL. ZC_FLIP may control flipping switches 403, and VDDS_VTH_SEL may control threshold selector switch 406.

Driver 415 may receive the signals time on (TON), time off (TOFF), and shunt enable (SHUNT ENABLE) and generate switching signals based thereon, where the switching signals turn transistors on and turn transistors off, to cause the inductor currents described above with respect to FIGS. 1B-1E. The switching signals may be generated at an appropriate voltage to cause the transistors to be either on or off.

The switching signal P3_CTRL may be coupled to the gate of transistor 108; the switching signal P 1_CTRL may be coupled to the gate of transistor 104; the switching signal N1_CTRL may be coupled to the gate of transistor 106; the switching signal Shunt_SW may control an on or off state of the shunt switch that couples the terminals of inductor 114; the switching signal N2_CTRL may be coupled to the gate of transistor 110; the switching signal P2_CTRL may be coupled to the gate of transistor 112.

FIG. 5 is an illustration of an example operation, which may be performed by the DC-DC converter 130, under control of controller 126, according to some embodiments. In FIG. 5, curve 501 shows an example value of the voltage level at VDDS, curve 502 shows an example value of the voltage level from VDDS at the inverting input of comparator 404, curve 503 shows an example value of the voltage level of VREF2_VDDS, curve 504 shows an example value of the voltage level of VREF1_VDDS, curve 505 shows an example level of VSCMP, and curve 506 shows an example of the inductor current I_{L}, according to some embodiments.

Between times T0 and T1, the DC-DC converter 130 may operate in a buck-boost mode to provide an adequate voltage level at VDDS to power, e.g., other circuits 226 and 224. For instance, the “normal operation” between times T0 and T1 may correspond to start up or other operation sufficient to power, e.g., other circuits 226 and 224, though not necessarily adequate for powering RF circuits 222.

During this buck-boost mode, DC-DC converter 130 may provide a voltage level for VDDS that is above VREF1_VDDS and make adjustments to TON and TOFF based on the value of VSCMP. The current through the inductor 114 may cycle between IPEAK1 and zero. Between times T0 and T1, an increase in the current may be represented by the current in FIG. 1B, and a decrease in the current may be represented by the current in FIG. 1C.

At time T1, the threshold selector switch 406 may, based on VDDS_VTH_SEL, may switch from using VREF1_VDDS to using VREF2_VDDS. For instance, the lookup tables 411 and 412 may output different values, which may cause different values for the TON and TOFF signals. A result is that the capacitor 116 charges, and the voltage VDDS increases through time T3. At time T2, VSCMP goes low, corresponding to a peak value of the current, and the DC-DC converter 130 completes a last current reduction to zero of the buck-boost operation.

At time T3, VDDS is at a peak, the inductor current is at a zero crossing, and the DC-DC converter 130 begins a buck operation, referred to as a “reverse buck” operation in FIG. 5. For instance, the pre-charge operation between times T1 and T2 may be performed in anticipation of powering on RF circuits 222 (e.g., an RF transceiver), and operation of the RF transceiver for RF transmitting and/or receiving may begin at time T3.

The DC-DC converter 130 may then perform actions illustrated above with respect to FIGS. 1D and 1E, where a change in the inductor current from zero to IPEAK2 is illustrated by FIG. 1D, and a change in the inductor current from IPEAK2 to zero is illustrated by FIG. 1E.

In one example, the time from T0 to time T3 corresponds to the IPEAK value being set at a first value (IPEAK1), and the time from T3 to T4 corresponds to the IPEAK value being set at a second value (IPEAK2), where the first value and the second value are opposite in polarity. Between times T3 and T4, the lookup tables 411 and 412 may output different values to result in different values for TON and TOFF. The times between T3 and T9 represent a time in which RF circuits 222 may be operated, such as to provide transmission and reception of RF signals. The transition from buck-boost operation to buck operation at time T3 corresponds to a zero crossing of the inductor current. During the buck operation, the inductor current goes from a zero crossing to a peak at IPEAK2 and back to zero for multiple cycles.

Between times T4 and T5, the DC-DC converter 130 may perform another buck-boost operation, which may use a third value for IPEAK (IPEAK11), where IPEAK11 may be larger in magnitude than IPEAK1. In one example, the buck-boost operation between times T4 and T5 may provide additional charging to capacitor 116. Time T4 corresponds to a zero crossing of the inductor current, as does time T5. The elapsed time between T4 and T5 includes a peak in the inductor current that corresponds to IPEAK1. Although only one cycle is shown between T4 and T5, various embodiments may include multiple cycles of buck-boost being performed between times T4 and T5.

Between times T5 and T6, the DC-DC converter 130 may perform another buck operation, similar to the buck operation between times T3 and T4. Between times T6 and T7, the DC-DC converter 130 may perform another buck-boost operation, similar to the buck-boost operation between times T4 and T5. Between times T7 and T8, the DC-DC converter 130 may perform a buck operation, similar to the buck operation performed between times T3 and T4, and ending at time T8, at which VSCMP goes high. Of note in FIG. 5 is that the voltage level at VDDS decreases between times T3 and T9.

Table 1 provides an explanation for the various parameters (e.g., TON1, etc.), and it is relevant to FIGS. 4-6.

TABLE 1

| RF On | |
|---|---|
| or OFF | Parameters |
| Only | IPEAK1 → IPEAK value |
| Buck- | TON1 → TON time for corresponding IPEAK1 (transistors |
| Boost | 104 and 110 - ON time) |
| (e.g., | TOFF1 → TOFF time for corresponding IPEAK1 |
| T0-T3) | (transistors 112 and 106 - ON time) |
| | ZC1 → zero cross output |
| | DCH1_OFFSET → Circuit 413 stores TOFF adjustment bits |
| | by observing zero cross detector output; after each DC-DC |
| | cycle, these bits may be incremented if TOFF1 time is |
| | smaller or may be decremented if TOFF1 time is more. ZC |
| | detects inductor current zero crossing; if inductor current is |
| | positive then TOFF1 time is less and output of zero cross is |
| | 1. if inductor current is negative then TOFF1 time is more |
| | and output of zero cross is 0. |
| Reverse | IPEAK11 → IPEAK value used in Buck-Boost Mode (higher |
| Buck | than only buck-boost Mode IPEAK) |
| con- | IPEAK2 → IPEAK value used in Reverse Buck-Boost Mode |
| verter + | TON11 → TON time for corresponding IPEAK11 (transistors |
| Buck- | 104 and 110 - ON time) |
| Boost | TOFF11 → TOFF time for corresponding IPEAK11 |
| Mode | (transistors 112 and 106 - ON time) |
| (e.g., | ZC11 → zero cross output |
| T3-T9) | TON2 → TON time for corresponding IPEAK2 (transistors |
| | 112 and 108 - ON time) |
| | TOFF2 → TOFF time for corresponding IPEAK2 (transistors |
| | 110 and 108 - ON time) |
| | ZC2 → zero cross output |
| | DCH2_OFFSET → Circuit 413 stores TOFF2 adjustment |
| | bits by observing zero cross detector output; after each DC- |
| | DC cycle, these bits may be incremented if TOFF2 time is |
| | smaller or may be decremented if TOFF2 time is more. ZC |
| | detects inductor current zero crossing; if inductor current is |
| | positive then TOFF2 time is less and output of zero cross is |
| | 1. if inductor current is negative then TOFF2 time is more |
| | and output of zero cross is 0. |
| | RBuckCount → counts number of reverse buck-boost cycles |
| | before one buck-boost operation happens |
| | Rmax → sets max reverse buck-boost cycles after one |
| | buck-boost cycle |

FIG. 6 is an illustration of example operation 600 of finite state machine 414, according to some embodiments. FIG. 6 illustrates multiple control signals in addition to the control signals in Table 1. For instance, DCDC_EN is an on/off control signal for the DC-DC converter 130. RF_EN is a control signal that causes DC-DC converter 130 to enter a buck operation to provide current at VDDR when RF_EN is high and to cause DC-DC converter 130 to end the buck operation when RF_EN is low. For instance, RF_EN may be set to high when RF circuits 222 are enabled and set to low ehen RF circuits 222 are not enabled.

State 610 is an off state or the DC-DC converter 130, and at state 610, the DC-DC converter may not perform a buck-boost operation or a buck operation. State 620 is a buck-boost operation, and it corresponds to the actions between times T0 and T1 of FIG. 5. State 630 is a pre-charge operation, and it corresponds to the actions between times T1 and T3 of FIG. 5. State 640 is a buck operation, such as the buck operation between times T3 and T4 of FIG. 5. State 650 is a buck-boost operation, such as the buck-boost operation between times T4 and T5 of FIG. 5.

State 610 corresponds to the DC-DC enable signal being low, and when the DC-DC enable signal goes high, then operation 600 transitions to state 611. For instance, the DC-DC enable signal may be generated by the logic 410 of FIG. 4.

At state 611, the finite state machine 414 determines whether RF_EN signal is low or high. If the RF_EN signal is high, then the state machine 414 transitions to state 641, and if the RF_EN signal is low, then the state machine 414 transitions to state 621.

State 621 includes flipping switches 403 to set itself so that comparator 402 determines SW1 minus SW2. State 621 also includes using VREF1_VDDS at comparator 404 via switch 406. After 621, finite state machine 414 transitions to state 622, where it determines the states of RF_EN and VSCMP. If RF_EN is high, then finite state machine 414 transitions to state 610. Otherwise, the next action depends upon the value of VSCMP. If VSCMP is high, which indicates that the measured VDDS has fallen below the reference, and state machine 414 may then transition through states 623 and 624. States 623 and 624 include transitioning through different values for time on until VSCMP goes low, at which point state machine 414 transitions to state 622.

Should RF_EN be high, then state machine 414 may then transition to state 641, which causes comparator 404 to use VREF2_VDDS via switch 406 and causes input flipping switches 403 to cause comparator 402 to determine SW2 minus SW1. State 641 may also include initializing RBuckCount to zero.

From state 641, state machine 414 may then transition to state 631. State 641 includes checking VSCMP and RF_EN. If RF_EN is low, then state machine 414 may transition back to state 610 via state 642. If VSCMP is high (e.g., if the measured VDDS is below the threshold VREF2_VDDS), then state machine 414 may transition through states 632 and 633, which update values for time on and time off until VSCMP goes low (e.g., if the measured VDDS is above the VREF2_VDDS). Once the VSCMP goes low, then state machine 414 may transition from state 631 to state 642.

Assuming that RF_EN is still high, then at state 642, with VSCMP being high, then state machine 414 may check the value for VRCMP. If VRCMP is high (e.g., VDDR is below the threshold VREF_VDDR), then state machine 414 transitions through states 643-646. State 643 includes checking the RBuckCount, and if the RBuckCount is equal to or less than the max (Rmax), then state machine 414 may perform buck operations, through as many cycles as it takes to reach Rmax. As long as VRCMP is high, then state machine 414 may reset RBuckCount and repeat the cycles of the buck operations. Once VRCMP goes low, then, at state 644, state machine 414 may transition to state 642.

At state 642, assuming RF is enabled and VRCMP is low, then should the value of VSCMP go high, then state machine 414 may transition to states 651 and 652 to perform buck-boost operations until VSCMP goes low. Once VSCMP goes low, then state machine 414 may transition to state 642 and then may repeat further cycles of the buck operation at states 643-646.

While in the state 640, should RF_EN go low, then state machine 414 may return to state 610.

Operation 600 of FIG. 6 may be used in any of a variety of appropriate applications. Some applications may include bursty RF operations, where RF operations may use relatively high amounts of current that may be above a level that may be supplied by a battery. Operation 600 may allow for charging a first capacitor (e.g., capacitor 116) and then using energy from the charged capacitor to provide a relatively large amount of current for a relatively short time to support the RF operation. Once the RF operation ends, then the state machine may return to buck-boost at state 620 or an off state at state 610.

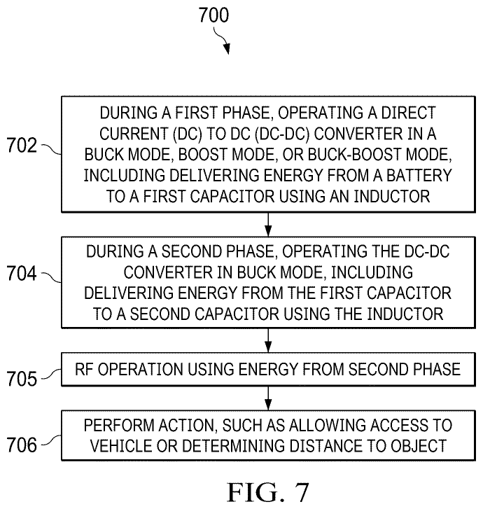

FIG. 7 is an illustration of example method 700, according to some embodiments. Example method 700 may be performed by any of the circuits discussed above with respect to FIGS. 1A-1E, 2, and 3 under control of a control system, such as controller 126 of FIG. 4.

At action 702, a DC-DC converter is in a first phase, and it operates in a buck mode, boost mode, or buck-boost mode. Action 702 may include delivering energy from a battery to a first capacitor using an inductor. For instance, the first phase may include state 630 of FIG. 6 delivering current to charge capacitor 116. In such an example, the DC-DC converter may charge the capacitor using energy from a battery, such as battery 102. In one implementation, the battery voltage may be lower than the desired voltage at the capacitor, in which case the DC-DC converter may use buck-boost mode or boost mode. In another implementation, the battery voltage may be higher than the desired voltage at the capacitor, in which case the DC-DC converter may use buck mode to charge the capacitor. An example of the first phase is also described above with respect to FIGS. 1B-1C.

Action 702 may also include powering other circuits, such as other circuits 226 and 224 (FIG. 2) using the battery power and/or energy from the first phase.

At action 704, there is a second phase in which the DC-DC converter operates in buck mode, including delivering energy from the first capacitor to a second capacitor using the inductor. An example may include state 640, where a buck mode is used to charge capacitor 118 from the energy stored at capacitor 116. An example of the second phase is also described above with respect to FIGS. 1D-1E. Action 704 may also include a voltage regulator, such as LDO RF 122, supplementing the current provided by the buck mode.

Action 704 may also include powering a circuit, such as an analog circuit (e.g., an RF receiver, transmitter, or transceiver). For instance, action 705 includes performing an RF operation using energy from the second phase. The RF operation may be performed according to any appropriate protocol, such as Bluetooth, BLE, UWB, Wi-Fi, and/or the like.

Action 705 may be under control of digital logic, such as described above with respect to other circuits 224 of FIG. 2. In one example, a processing circuit may execute computer-readable instructions to perform functionality of a system that includes RF operations.

In one example, at action 706, the functionality of the processing circuit may use the RF operation in furtherance of a task. An example of a task may include a radar task to determine a distance to an object or the presence of an object. Another example of the task may include allowing access to a vehicle. For instance, circuits 200 or 300 of FIG. 2 or 3 may be implemented in a keyfob, smart phone, or other device that operates in conjunction with an access system of a vehicle. Circuit 200 or circuit 300 may then receive and/or transmit RF signals to cause the vehicle to unlock, lock, or perform another function. In yet another example, circuit 200 or circuit 300 may be used in an access device to allow a user to unlock a door to provide access to a room or other resource. Of course, those are just examples and any appropriate task may be performed at action 706.

Example embodiments of the present disclosure are summarized here. Other embodiments can also be understood from the entirety of the specification and the claims filed herein.

Example 1. A method including: during a first phase, operating a direct current (DC) to DC (DC-DC) converter in a buck mode, boost mode, or buck-boost mode, including delivering energy from a battery to a first capacitor using an inductor; and during a second phase, operating the DC-DC converter in buck mode, including delivering energy from the first capacitor to a second capacitor using the inductor.

Example 2. The method of example 1, where the DC-DC converter includes: a first transistor having a current path terminal coupled between the battery and a first terminal of the inductor, a second transistor having a current path terminal coupled between the first terminal of the inductor and ground, and a third transistor having a current path terminal coupled between a second terminal of the inductor and ground, the method including: during the first phase, turning the first transistor on, turning the second transistor off, and turning the third transistor on, to charge the inductor.

Example 3. The method of one of examples 1 or 2, where the DC-DC converter further includes: a fourth transistor having a current path terminal coupled between the second terminal of the inductor and the first capacitor, the method including: during the first phase, and after charging the inductor, turning off the first transistor, turning on the second transistor, and turning on the fourth transistor, to charge the first capacitor.

Example 4. The method of one of examples 1 to 3, where the DC-DC converter further includes: a fifth transistor having a current path terminal coupled between the first terminal of the inductor and the second capacitor, the method further including: during the second phase, delivering energy from the first capacitor to the second capacitor via the current path terminal of the fifth transistor.

Example 5. The method of one of examples 1 to 4, where the method includes: during the second phase, turning on the fifth transistor, turning off the first transistor, turning off the second transistor, and turning off the third transistor; and turning on the fourth transistor in response to a level of current through the inductor.

Example 6. The method of one of examples 1 to 5, further including, during the second phase, charging the second capacitor via a voltage regulator that is coupled between the first capacitor and the second capacitor.

Example 7. The method of one of examples 1 to 6, where a radio frequency (RF) circuit is coupled to a terminal of the second capacitor, the method further including: operating the RF circuit during the second phase; transitioning from the second phase to the first phase; and turning off the RF circuit during transitioning from the second phase to the first phase or during the first phase.

Example 8. The method of one of examples 1 to 7, where an ultra-wideband (UWB) circuit is coupled to a terminal of the second capacitor, the method further including: operating the UWB circuit during the second phase; transitioning from the second phase to the first phase; and turning off the UWB circuit during transitioning from the second phase to the first phase or during the first phase.

Example 9. The method of one of examples 1 to 8, further including alternating between the first phase and the second phase during a UWB communication exchange by the UWB circuit.

Example 10. The method of one of examples 1 to 9, where operating the UWB circuit includes: transmitting wireless pulses from the UWB circuit; receiving reflections of the wireless pulses from an object; and detecting a distance from a system having the DC-DC converter to the object based on the reflections.

Example 11. The method of one of examples 1 to 10, where operating the UWB circuit includes: communicating from the UWB circuit to a device; and determining whether to provide access to an automobile based on the communicating.

Example 12. The method of one of examples 1 to 11, where a peak level current through the inductor is larger during the second phase than in the first phase.

Example 13. The method of one of examples 1 to 12, where delivering energy from the first capacitor to the second capacitor includes: conducting a current through the inductor, where the current through the inductor is larger than a maximum current of the battery.

Example 14. The method of one of examples 1 to 13, where delivering energy from the first capacitor to the second capacitor includes: conducting a current through the inductor, where a peak level of the current through the inductor is larger than a maximum peak current of the battery.

Example 15. The method of one of examples 1 to 14, where delivering energy from the first capacitor to the second capacitor includes: conducting a current through the inductor, where an average level of the current through the inductor is larger than a maximum average current of the battery.

Example 16. The method of one of examples 1 to 15, where operating the DC-DC converter in the buck mode during the second phase includes: operating the DC-DC converter as a constant current source providing a constant current, where the constant current corresponds to a saturated current of the DC-DC converter in buck mode.

Example 17. The method of one of examples 1 to 16, where delivering energy from the battery to the first capacitor includes: causing a monotonic voltage increase across the first capacitor.

Example 18. The method of one of examples 1 to 17, where delivering energy from the battery to the first capacitor includes: regulating a voltage across the first capacitor to a target voltage.

Example 19. The method of one of examples 1 to 18, where delivering energy from the battery to the first capacitor includes: turning off a transistor, disposed between the battery and the inductor, in response to a current through the inductor reaching a defined level.

Example 20. The method of one of examples 1 to 19, further including: powering a power on reset (POR) circuit via the battery before the first phase.

Example 21. The method of one of examples 1 to 20, further including operating the DC-DC converter in buck mode during the first phase.

Example 22. The method of one of examples 1 to 21, further including operating the DC-DC converter in boost mode during the first phase.

Example 23. The method of one of examples 1 to 22, further including operating the DC-DC converter in buck-boost mode during the first phase.

Example 24. The method of one of examples 1 to 23, further including, during the second phase, turning on a voltage regulator having an output coupled to the second capacitor in response to a peak current flowing through the inductor reaching a current threshold.

Example 25. The method of one of examples 1 to 24, further including, during the second phase, delivering current to the second capacitor via the inductor with the DC-DC converter without turning on a regulator having an output coupled to the second capacitor when the current via the inductor is lower than a current threshold.

Example 26. The method of one of examples 1 to 25, further including: receiving a control signal; and beginning operation in the second phase in response to the control signal.

Example 27. The method of one of examples 1 to 26, where the control signal is associated with beginning a transmitting or receiving operation of a wireless device.

Example 28. The method of one of examples 1 to 27, further including: during operation in the first phase, measuring a voltage at a terminal of the first capacitor; and adjusting a duty cycle of a control signal based on measuring the voltage.

Example 29. The method of one of examples 1 to 28, where adjusting the duty cycle of the control signal includes increasing the duty cycle of the control signal to increase the voltage.

Example 30. The method of one of examples 1 to 29, further including: during operation of the first phase, measuring a voltage at a terminal of the first capacitor; and ending operation in the first phase in response to measuring the voltage.

Example 31. The method of one of examples 1 to 30, further including: during the second phase, measuring a voltage at a terminal of the first capacitor; and beginning operation in the first phase in response to measuring the voltage.

Example 32. The method of one of examples 1 to 31, further including: subsequent to beginning operation in the first phase, measuring a subsequent voltage at the terminal of the first capacitor; and in response to measuring the subsequent voltage, returning to operation in the second phase.

Example 33. An electronic circuit including: a first current path including: a first terminal; a second terminal coupled to the first terminal; a third terminal configured to be coupled to the second terminal via an inductor; a fourth terminal; and a first transistor having a current path coupled between the third and fourth terminals; and a second current path including: the second terminal and the third terminal; a fifth terminal; and a second transistor having a current path coupled between the second terminal and the fifth terminal.

Example 34. The electronic circuit of example 33, further including a first capacitor coupled to the fourth terminal, and a second capacitor coupled to the fifth terminal.

Example 35. The electronic circuit of one of examples 33 or 34, further including a battery coupled to the first terminal.

Example 36. The electronic circuit of one of examples 33 to 35, where the first current path is configured to have a current direction from the first terminal to the fourth terminal via the current path of the first transistor, and where the second current path is configured to have a current direction from the fourth terminal to the fifth terminal via the current path of the first transistor.

Example 37. The electronic circuit of one of examples 33 to 36, further including: a voltage regulator having an input coupled to the fourth terminal, and an output coupled to the fifth terminal.

Example 38. The electronic circuit of one of examples 33 to 37, where the voltage regulator includes a low dropout (LDO) voltage regulator.

Example 39. The electronic circuit of one of examples 33 to 38, where an integrated circuit includes the first and second current paths, and where the voltage regulator is external to the integrated circuit.

Example 40. The electronic circuit of one of examples 33 to 39, further including: a third transistor having a current path coupled between the first terminal and the second terminal.

Example 41. The electronic circuit of one of examples 33 to 40, further including: a fourth transistor having a current path coupled between the second terminal and a first power terminal.

Example 42. The electronic circuit of one of examples 33 to 41, where the first power terminal is configured to be coupled to a negative terminal of a battery, and where the first terminal is configured to be coupled to a positive terminal of the battery.

Example 43. The electronic circuit of one of examples 33 to 42, where the electronic circuit includes: an RF circuit; and a direct current (DC) to DC (DC-DC) controller of a DC-DC converter, where the DC-DC controller is configured to cause current to be conducted along the first current path during a pre-charge phase of the DC-DC converter, and cause current to be conducted along the second current path during a radio frequency (RF) operation phase to power the RF circuit.

Example 44. The electronic circuit of one of examples 33 to 43, where the −DC-DC controller is configured to cause current to be conducted along the first current path during the pre-charge phase to charge an inductor using energy from a battery.

Example 45. The electronic circuit of one of examples 33 to 44, where the electronic circuit includes a direct current (DC) to DC (DC-DC) controller of a DC-DC converter, where the DC-DC controller is configured to cause current to be conducted along the first current path during a buck or boost or buck-boost phase of the DC-DC converter, and cause current to be conducted along the second current path during a reverse buck phase of the DC-DC converter.

Example 46. The electronic circuit of one of examples 33 to 45, further including: a third transistor having a current path coupled between the first terminal and the second terminal; a fourth transistor having a current path coupled between the second terminal and a first power terminal; and a controller configured to cause current to be conducted along the second current path during a forward mode of operation of the electronic circuit, including turning off the third transistor and the fourth transistor during a transition from the forward mode of operation of the electronic circuit to a reverse mode of operation of the electronic circuit.

Example 47. The electronic circuit of one of examples 33 to 46, further including: a controller configured to turn off the first transistor, during a time in which current is caused to flow in the second current path, based on a level of the current through the inductor.

Example 48. The electronic circuit of one of examples 33 to 47, further including: a power on reset (POR) circuit coupled to the first terminal and the second terminal and configured to receive power from a battery coupled to the first terminal.

Example 49. The electronic circuit of one of examples 33 to 48, further including: a radio frequency (RF) circuit coupled to the fifth terminal, where the RF circuit is configured to receive power from a first capacitor coupled to the fourth terminal.

Example 50. The electronic circuit of one of examples 33 to 49, further including: an ultra-wideband (UWB) circuit, coupled to the fifth terminal, where the UWB circuit is configured to receive power from a first capacitor coupled to the fourth terminal.

Example 51. The electronic circuit of one of examples 33 to 50, where the electronic circuit is integrated in an integrated circuit, the electronic circuit further including sixth terminal, where the UWB circuit is configured to receive power from the first capacitor via the fifth and sixth terminals.

Example 52. The electronic circuit of one of examples 33 to 51, where a second capacitor external to the integrated circuit is coupled to the fifth and sixth terminals.

Example 53. An integrated circuit including: a first terminal; a second terminal coupled to the first terminal; a first transistor having a current path coupled between the first terminal and the second terminal; a second transistor having a current path coupled between the second terminal and a first power terminal; a third terminal; a fourth terminal; a third transistor having a current path coupled between the third terminal and the fourth terminal; a fifth terminal; a fourth transistor having a current path coupled between the second terminal and the fourth terminal; and a voltage regulator having an input coupled to the fourth terminal and an output coupled to the fifth terminal.

Example 54. The integrated circuit of example 53, further including: a fifth transistor having a current path coupled between the third terminal and the first power terminal, where the current path of third transistor is coupled to the current path of the fifth transistor.

Example 55. The integrated circuit of one of examples 53 or 54, where the third and fifth transistors are configured to operate as a direct current (DC) to DC (DC-DC) converter.

Example 56. The integrated circuit of one of examples 53 to 55, further including a controller configured to: cause the third and fifth transistors to operate as a direct current (DC) to DC (DC-DC) converter in forward mode during a first phase; and cause the third and fifth transistors to operate as a DC-DC converter in reverse mode during a second phase.

Example 57. The integrated circuit of one of examples 53 to 56, where the controller is configured to control an on state and an off state of the fifth transistor based on a level of a current flowing between the second and third terminals.

Example 58. The integrated circuit of one of examples 53 to 57, further including an RF circuit having an input coupled to the output of the voltage regulator and the current path of the fourth transistor, where the RF circuit is configured to operate in communication mode during the second phase, and in a low power mode during the first phase.

Example 59. The integrated circuit of one of examples 53 to 58, further including: a sixth terminal; and an RF circuit configured to be powered via the sixth terminal, where the RF circuit is configured to operate in communication mode during the second phase, and in a non-communication mode during the first phase.

Example 60. The integrated circuit of one of examples 53 to 59, where the controller is configured to alternate between the first and second phases.

Example 61. The integrated circuit of one of examples 53 to 60, further including a controller configured to: cause the third and fifth transistors to act as a direct current (DC) to DC (DC-DC) converter in a buck mode by turning off the first transistor and the second transistor and turning on the fourth transistor.

Example 62. The integrated circuit of one of examples 53 to 61, where the controller is configured to turn on the voltage regulator during the buck mode.

Example 63. The integrated circuit of one of examples 53 to 62, further including a radio frequency (RF) transceiver coupled to the fifth terminal, where the RF transceiver is configured to: receive power from a first capacitor coupled to the fourth terminal during the buck mode; and transmit and receive RF signals while receiving the power.

Example 64. The integrated circuit of one of examples 53 to 63, further including an ultra-wideband (UWB) circuit including the RF transceiver, and where the UWB circuit is configured to: detect a distance to an object by transmitting and receiving the RF signals.

Example 65. The integrated circuit of one of examples 53 to 64, further including an ultra-wideband (UWB) circuit including the RF transceiver, and where the UWB circuit is configured to: control access to an automobile in response to transmitting and receiving the RF signals.

Example 66. The integrated circuit of one of examples 53 to 65, further including a battery coupled to the first terminal.

Example 67. The integrated circuit of one of examples 53 to 66, where the first terminal is coupled to a positive terminal of the battery, and where the first power terminal is coupled to a negative terminal of the battery.

Example 68. The integrated circuit of one of examples 53 to 67, further including an inductor coupled to the first terminal.

Example 69. The integrated circuit of one of examples 53 to 68, further including a first capacitor coupled to the fourth terminal.

Example 70. The integrated circuit of one of examples 53 to 69, further including a second capacitor coupled to the fifth terminal.

Example 71. The integrated circuit of one of examples 53 to 70, further including: a controller, where the controller is configured to: cause the integrated circuit to act as a direct current (DC) to DC (DC-DC) converter in a boost buck mode by turning on the first transistor and the third transistor to create current through the second terminal and the third terminal and subsequently turning off the first transistor and turning on the second transistor to charge the first capacitor through the fourth terminal; and cause the integrated circuit to act as the DC-DC converter in a buck mode by turning off the first transistor and the second transistor and turning on the fourth transistor to charge the second capacitor via the fifth terminal.

Example 72. An integrated circuit (IC) including: a first terminal configured to be coupled to an inductor; a second terminal configured to be coupled to the inductor; a third terminal configured to be coupled to a battery; a fourth terminal configured to be coupled to a first capacitor; a fifth terminal configured to be coupled to a second capacitor and to a radio frequency (RF) circuit; a first transistor disposed in a current path between the second terminal and the fifth terminal; a direct current (DC) to DC (DC-DC) converter configured to operate: in a forward mode in which the DC-DC converter receives power to charge the first capacitor via the first terminal, the second terminal, the third terminal, and the fourth terminal; and in a reverse mode in which the DC-DC converter transfers power from the first capacitor to the RF circuit via the first transistor and the fifth terminal.

Example 73. The IC of example 72, further including: a sixth terminal configured to be coupled to, where the second capacitor and the RF circuit.

Example 74. The IC of one of examples 72 or 73, further including the RF circuit coupled to the fifth terminal without using a conductor external to the IC.

Example 75. An integrated circuit including: first, second, third, and fourth terminals; a first transistor having a current path coupled between the first terminal and the fourth terminal; and a DC-DC converter coupled between the second and third terminals, where the DC-DC converter is configured to: during a first phase, operate in a forward mode to deliver energy to the third terminal via the first and second terminals; and during a second phase, operate in reverse mode to deliver energy from the third terminal to fourth terminal via the first and second terminals and the current path of the first transistor.

While various examples of the present disclosure have been described above, it should be understood that they have been presented by way of example only and not limitation. Numerous changes to the disclosed examples can be made in accordance with the disclosure herein without departing from the spirit or scope of the disclosure. Modifications are possible in the described embodiments, and other embodiments are possible, within the scope of the claims. Thus, the breadth and scope of the present invention should not be limited by any of the examples described above. Rather, the scope of the disclosure should be defined in accordance with the following claims and their equivalents.

What is claimed is:

1. A method comprising:
during a first phase, operating a direct current (DC) to DC (DC-DC) converter in a buck mode, boost mode, or buck-boost mode, including delivering energy from a battery to a first capacitor using an inductor; and
during a second phase, operating the DC-DC converter in buck mode, including delivering energy from the first capacitor to a second capacitor using the inductor.

2. The method of claim 1, wherein the DC-DC converter includes:
a first transistor having a current path terminal coupled between the battery and a first terminal of the inductor,
a second transistor having a current path terminal coupled between the first terminal of the inductor and ground, and
a third transistor having a current path terminal coupled between a second terminal of the inductor and ground;
a fourth transistor having a current path terminal coupled between the second terminal of the inductor and the first capacitor; and
a fifth transistor having a current path terminal coupled between the first terminal of the inductor and the second capacitor, the method further comprising:
during the first phase, turning the first transistor on, turning the second transistor off, and turning the third transistor on, to charge the inductor;
during the first phase, and after charging the inductor, turning off the first transistor, turning on the second transistor, and turning on the fourth transistor, to charge the first capacitor;
during the second phase, turning on the fifth transistor, turning off the first transistor, turning off the second transistor, and turning off the third transistor; and
during the second phase, delivering energy from the first capacitor to the second capacitor via the current path terminal of the fifth transistor; and
turning on the fourth transistor in response to a level of current through the inductor.

3. The method of claim 1, further comprising, during the second phase, charging the second capacitor via a voltage regulator that is coupled between the first capacitor and the second capacitor.

4. The method of claim 1, wherein a radio frequency (RF) circuit is coupled to a terminal of the second capacitor, the method further comprising:
operating the RF circuit during the second phase;
transitioning from the second phase to the first phase; and
turning off the RF circuit during transitioning from the second phase to the first phase or during the first phase.

5. The method of claim 1, wherein a peak level current through the inductor is larger during the second phase than in the first phase.

6. The method of claim 1, wherein delivering energy from the first capacitor to the second capacitor comprises:
conducting a current through the inductor, wherein the current through the inductor is larger than a maximum current of the battery.

7. The method of claim 1, wherein delivering energy from the first capacitor to the second capacitor comprises:
conducting a current through the inductor, wherein a peak level of the current through the inductor is larger than a maximum peak current of the battery.

8. The method of claim 1, wherein delivering energy from the first capacitor to the second capacitor comprises:
conducting a current through the inductor, wherein an average level of the current through the inductor is larger than a maximum average current of the battery.

9. The method of claim 1, further comprising:
during operation of the first phase, measuring a voltage at a terminal of the first capacitor; and
ending operation in the first phase in response to measuring the voltage.

10. The method of claim 1, further comprising:
during the second phase, measuring a voltage at a terminal of the first capacitor; and
beginning operation in the first phase in response to measuring the voltage.

11. The method of claim 10, further comprising:
subsequent to beginning operation in the first phase, measuring a subsequent voltage at the terminal of the first capacitor; and
in response to measuring the subsequent voltage, returning to operation in the second phase.

12. An electronic circuit comprising:
a first current path including:
a first terminal;
a second terminal coupled to the first terminal;
a third terminal configured to be coupled to the second terminal via an inductor;
a fourth terminal; and
a first transistor having a current path coupled between the third and fourth terminals; and
a second current path including:
the second terminal and the third terminal;
a fifth terminal; and
a second transistor having a current path coupled between the second terminal and the fifth terminal.

13. The electronic circuit of claim 12, wherein the first current path is configured to have a current direction from the first terminal to the fourth terminal via the current path of the first transistor, and wherein the second current path is configured to have a current direction from the fourth terminal to the fifth terminal via the current path of the first transistor.

14. The electronic circuit of claim 12, wherein the electronic circuit comprises:
an RF circuit; and
a direct current (DC) to DC (DC-DC) controller of a DC-DC converter, wherein the DC-DC controller is configured to cause current to be conducted along the first current path during a pre-charge phase of the DC-DC converter, and cause current to be conducted along the second current path during a radio frequency (RF) operation phase to power the RF circuit.

15. The electronic circuit of claim 14, wherein the −DC-DC controller is configured to cause current to be conducted along the first current path during the pre-charge phase to charge an inductor using energy from a battery.

16. The electronic circuit of claim 12, further comprising:
a third transistor having a current path coupled between the first terminal and the second terminal;
a fourth transistor having a current path coupled between the second terminal and a first power terminal; and
a controller configured to cause current to be conducted along the second current path during a forward mode of operation of the electronic circuit, including turning off the third transistor and the fourth transistor during a transition from the forward mode of operation of the electronic circuit to a reverse mode of operation of the electronic circuit.

17. An integrated circuit (IC) comprising:
a first terminal configured to be coupled to an inductor;
a second terminal configured to be coupled to the inductor;
a third terminal configured to be coupled to a battery;
a fourth terminal configured to be coupled to a first capacitor;
a fifth terminal configured to be coupled to a second capacitor and to a radio frequency (RF) circuit;
a first transistor disposed in a current path between the second terminal and the fifth terminal;
a direct current (DC) to DC (DC-DC) converter configured to operate:
in a forward mode in which the DC-DC converter receives power to charge the first capacitor via the first terminal, the second terminal, the third terminal, and the fourth terminal; and
in a reverse mode in which the DC-DC converter transfers power from the first capacitor to the RF circuit via the first transistor and the fifth terminal.

18. The IC of claim 17, further comprising:
a sixth terminal configured to be coupled to the second capacitor and the RF circuit.

19. The IC of claim 17, further comprising the RF circuit coupled to the fifth terminal without using a conductor external to the IC.

20. The IC of claim 17, further comprising:
a controller configured to turn on the first transistor to enable the reverse mode.
